(19) United States
(12) Patent Application Publication
(10) Pub. No.: US 2018/0120496 A1
(43) Pub. Date: May 3, 2018

(54) LIGHT GUIDING PLATES, BACKLIGHT MODULES, AND DOUBLE-SIDED DISPLAY DEVICES

(71) Applicant: Shenzhen China Star Optoelectronics Technology Co., Ltd., Shenzhen, Guangdong (CN)

(72) Inventor: Yong FAN, Shenzhen, Guangdong (CN)

(73) Assignee: Shenzhen China Star Optoelectronics Technology Co., Ltd., Shenzhen, Guangdong (CN)

(21) Appl. No.: 15/100,296

(22) PCT Filed: Apr. 8, 2016
(86) PCT No.: PCT/CN2016/078795

§ 371 Date: May 28, 2016

(30) Foreign Application Priority Data
Mar. 11, 2016 (CN) 201610139476.2

(51) Int. Cl. F21V 8/00

(52) U.S. Cl. CPC G02B 6/0063; G02B 6/0038; G02B 6/0043

(57) ABSTRACT

The present disclosure relates to a light guiding plate, a backlight module, and a double-sided display. The light guiding plate includes a light incident surface configured for guiding light beams from a light source toward the light guiding plate, a first light emitting surface, and a second light emitting surface. The first light emitting surface and the second light emitting surface are respectively configured with a plurality of prism microstructures and a plurality of dot microstructures to enhance a brightness of the light beams emitted out from the first light emitting surface and the second light emitting surface. With such configuration, the double-sided display may be thinner and lighter.

### BACKGROUND OF THE INVENTION

### 1. Field of the Invention

The present disclosure relates to liquid crystal display technology, and more particularly to a light guiding plate, a backlight module, and a double-sided display device.

### 2. Discussion of the Related Art

Double-sided displays have been widely adopted by commercial applications. Conventional double-sided display includes two plastic light guiding plates, two reflective sheets, and a metallic backplate arranged therebetween. Compared to two independent liquid crystal modules, such double-sided display comes up one backplate short. In order to save more materials so as to be thinner, it is necessary to enhance the structure of the double-sided display.

### SUMMARY

According to the present disclosure, a light guiding plate, a backlight module, and a double-sided display are proposed to provide a light and thin double-sided display.

In one aspect, a light guiding plate includes: a light incident surface is configured for guiding light beams from a light source toward the light guiding plate; a first light emitting surface is configured for guiding a portion of the light beams within the light guiding plate to emit out from the first light emitting surface, and the light beams emitted from the first light emitting surface operate as a first light source for a first display panel; a second light emitting surface is configured to guide other portion of the light beams to emit out from the second light emitting surface, and the light beams emitted from the second light emitting surface operate as a second light source for a second display panel; wherein the first light emitting surface and the second light emitting surface are respectively configured with a plurality of prism microstructures and a plurality of dot microstructures to enhance a brightness of the light beams emitted out from the first light emitting surface and the second light emitting surface; the prism microstructures and the dot microstructures on the first light emitting surface are respectively symmetrical with the prism microstructures and the dot microstructures on the second light emitting surface; and the light incident surface is a lateral surface connecting the first light emitting surface and the second light emitting surface, and the light source is arranged on an axis on the light incident surface.

Wherein the prism microstructures are arranged on the first light emitting surface and the second light emitting surface in sequence, and the prism microstructures are parallel to each other.

Wherein an apex angle of each of the prism microstructures is in a range between 80 and 120 degrees.

Wherein the dot microstructures on the first light emitting surface and the second light emitting surface are configured between two adjacent prism microstructures.

Wherein a gap between two adjacent dot microstructures on the same light emitting surface is in a range between 10 and 100 microns.

In another aspect, a light guiding plate includes: a light incident surface is configured for guiding light beams from a light source toward the light guiding plate; a first light emitting surface is configured for guiding a portion of the light beams within the light guiding plate to emit out from the first light emitting surface, and the light beams emitted from the first light emitting surface operate as a first light source for a first display panel; a second light emitting surface is configured to guide other portion of the light beams to emit out from the second light emitting surface, and the light beams emitted from the second light emitting surface operate as a second light source for a second display panel; and wherein the first light emitting surface and the second light emitting surface are respectively configured with a plurality of prism microstructures and a plurality of dot microstructures to enhance a brightness of the light beams emitted out from the first light emitting surface and the second light emitting surface.

Wherein the prism microstructures and the dot microstructures on the first light emitting surface are respectively symmetrical with the prism microstructures and the dot microstructures on the second light emitting surface.

Wherein the prism microstructures are arranged on the first light emitting surface and the second light emitting surface in sequence, and the prism microstructures are parallel to each other.

Wherein an apex angle of each of the prism microstructures is in a range between 80 and 120 degrees.

Wherein the dot microstructures on the first light emitting surface and the second light emitting surface are configured between two adjacent prism microstructures.

Wherein a gap between two adjacent dot microstructures on the same light emitting surface is in a range between 10 and 100 microns.

Wherein the light incident surface is a lateral surface connecting the first light emitting surface and the second light emitting surface, and the light source is arranged on an axis on the light incident surface.

In another aspect, a double-sided display includes: a first display panel; a second display panel; a light source; a light guiding plate, the light source is arranged on at least one lateral surface of the light guiding plate, the light source and the light guiding plate are arranged between the first display panel and the second display panel, and the light guiding plate includes: a light incident surface is configured for guiding light beams from a light source toward the light guiding plate; a first light emitting surface is configured for guiding a portion of the light beams within the light guiding plate to emit out from the first light emitting surface, and the light beams emitted from the first light emitting surface operate as a first light source for a first display panel; a second light emitting surface is configured to guide other portion of the light beams to emit out from the second light emitting surface, and the light beams emitted from the second light emitting surface operate as a second light source for a second display panel; and wherein the first light emitting surface and the second light emitting surface are respectively configured with a plurality of prism microstructures and a plurality of dot microstructures to enhance a brightness of the light beams emitted out from the first light emitting surface and the second light emitting surface.

In view of the above, the light guiding plate includes the first light emitting surface and the second light emitting surface opposite to each other. The first light emitting surface and the second light emitting surface are respectively configured with a plurality of prism microstructures and a plurality of dot microstructures to enhance the brightness of the light beams emitted out from the first light emitting surface and the second light emitting surface. The prism microstructures are integrated into the light guiding plate such that prism enhancement sheets at two sides of the light guiding plate of the double-sided display may be omitted, which results in a thinner and lighter double-sided display.

### BRIEF DESCRIPTION OF THE DRAWINGS

FIG. 1 is a schematic view of the light guiding plate in accordance with one embodiment.

FIG. 2 is a schematic view of the backlight module in accordance with one embodiment.

FIG. 3 is a schematic view of the double-sided display in accordance with one embodiment.

### DETAILED DESCRIPTION OF THE EMBODIMENTS

Embodiments of the invention will now be described more fully hereinafter with reference to the accompanying drawings, in which embodiments of the invention are shown.

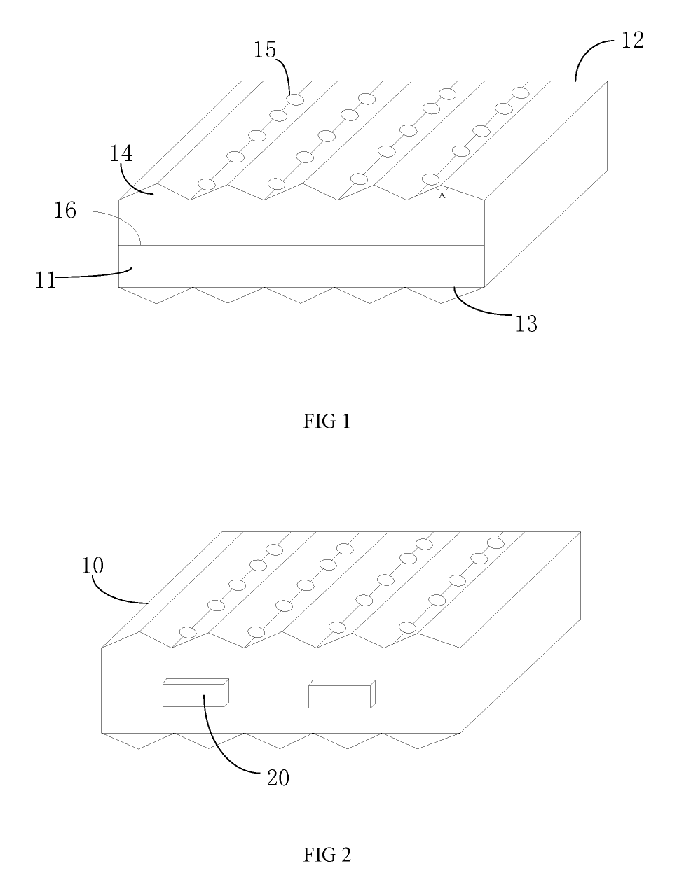

As shown in FIG. 1, the light guiding plate includes a light incident surface 11, a first light emitting surface 12, and a second light emitting surface 13. The light incident surface 11 connects with a light source. The light source emits light beams toward the light incident surface 11. The light incident surface 11 is configured for guiding the light beams from the light source toward the light guiding plate. The first light emitting surface 12 is configured for guiding a portion of the light beams within the light guiding plate to emit out from the first light emitting surface 12. The light beams emitted from the first light emitting surface 12 operate as a first light source for a first display panel. The second light emitting surface 13 is opposite to the first light emitting surface 12. The second light emitting surface 13 is configured to guide other portion of the light beams to emit out from the second light emitting surface 13. The light beams emitted from the second light emitting surface 13 operate as a second light source for a second display panel.

The first light emitting surface 12 and the second light emitting surface 13 are respectively configured with a plurality of prism microstructures 14 and a plurality of dot microstructures 15 to enhance the brightness of the light beams emitted out from the first light emitting surface 12 and the second light emitting surface 13.

In the embodiment, the prism microstructures 14 may be triangular prism to increase the density of the light beams. The structure of the prism microstructures 14 are the same. A length of the prism microstructure 14 may be the same with the length of one lateral side of the first light emitting surface 12 or the second light emitting surface 13. A bottom surface of the prism microstructures 14 is overlapped with the first light emitting surface 12 or the second light emitting surface 13. The dot microstructures 15 are reflective dots for reflecting the light beams from the internal of the light guiding plate.

In one embodiment, the light guiding plate includes the first light emitting surface 12 and the second light emitting surface 13 opposite to each other. The first light emitting surface 12 and the second light emitting surface 13 are respectively configured with a plurality of prism microstructures 14 and a plurality of dot microstructures 15 to enhance the brightness of the light beams emitted out from the first light emitting surface 12 and the second light emitting surface 13. In the embodiment, the prism microstructures 14 are integrated into the light guiding plate such that prism enhancement sheets at two sides of the light guiding plate of the double-sided display may be omitted, which results in a thinner and lighter double-sided display.

The prism microstructures 14 and the dot microstructures 15 on the first light emitting surface 12 are respectively symmetrical with the prism microstructures 14 and the dot microstructures 15 on the second light emitting surface 13.

In the embodiment, the structure of the prism microstructures 14 on the first light emitting surface 12 is the same with that of the prism microstructures 14 on the second light emitting surface 13. The structure of the dot microstructures 15 on the first light emitting surface 12 is the same with that of the prism microstructures 14 on the second light emitting surface 13. The prism microstructures 14 and the dot microstructures 15 on the first light emitting surface 12 are respectively symmetrical with the prism microstructures 14 and the dot microstructures 15 on the second light emitting surface 13. With such configuration, the light beams emitted from the first light emitting surface 12 and the second light emitting surface 13 may be more uniform such that the display performance of the first display panel may be the same with that of the second display panel.

The prism microstructures 14 are arranged on the first light emitting surface 12 and the second light emitting surface 13 in sequence. The prism microstructures 14 are parallel to each other.

In one embodiment, the prism microstructures 14 may be parallel to the lateral side of the first light emitting surface 12 or the second light emitting surface 13. In addition, the prism microstructures 14 on the first light emitting surface 12 are adjacent to each other in turn, and the prism microstructures 14 on the second light emitting surface 13 are adjacent to each other in turn, such that the bottom surfaces of the prism microstructures 14 on the first light emitting surface 12 cooperatively cover the first light emitting surface 12 and the bottom surfaces of the prism microstructures 14 on the second light emitting surface 13 cooperatively cover the second light emitting surface 13, which realizes the best display performance. When the prism microstructures 14 on the first light emitting surface 12 are symmetrical to the prism microstructures 14 on the second light emitting surface 13, the prism microstructures 14 on the first light emitting surface 12 are parallel to the prism microstructures 14 on the second light emitting surface 13.

An apex angle (A) of each of the prism microstructures 14 is in a range between 80 and 120 degrees, such as 80, 100, or 120 degrees. The light emitting efficiency of the prism microstructures 14 may be enhanced by configuring the apex angle to be in the above range.

The dot microstructures 15 on the first light emitting surface 12 and the second light emitting surface 13 are configured between two adjacent prism microstructures 14.

In the embodiment, the dot microstructures 15 on the first light emitting surface 12 are configured between two adjacent prism microstructures 14 on the first light emitting surface 12, and the dot microstructures 15 on the second light emitting surface 13 are configured between two adjacent prism microstructures 14 on the second light emitting surface 13. In the embodiment, the prism microstructures 14 on the first light emitting surface 12 and the second light emitting surface 13 are parallel to each other, and are adjacent to each other. The adjacent portion of the two prism microstructures 14 is a line, and the dot microstructures 15 are respectively arranged on the line.

A gap between two adjacent dot microstructures 15 on the same light emitting surface is in a range between 10 and 100 microns, such as 10, 50, or 100 microns, so as to enhance the light guiding efficiency of the light guiding plate. That is, the gap between two adjacent dot microstructures 15 on the first light emitting surface 12 is in the range between 10 and 100 microns, and the gap between two adjacent dot microstructures 15 on the second light emitting surface 13 is in the range between 10 and 100 microns. In the embodiment, the gap between two adjacent dot microstructures 15 arranged in the adjacent portion of two adjacent prism microstructures 14 is in the range between 10 and 100 microns.

The light incident surface 11 is the lateral surface connecting the first light emitting surface 12 and the second light emitting surface 13, and the light source is arranged on an axis 16 on the light incident surface 11. The axis 16 is a connecting line of the middle points of two lateral edges of the light incident surface 11. The gap between the axis 16 and the first light emitting surface 12 is the same with the gap between the axis 16 and the second light emitting surface 13. In the embodiment, the light emitting performance of the first light emitting surface 12 and the second light emitting surface 13 may be enhanced by configuring the light source on the axis 16 of the light incident surface 11. In this way, the display performance of the first display panel may be the same with that of the second panel.

In one example, the light incident surface 11 may be one lateral surface connecting the first light emitting surface 12 and the second light emitting surface 13. In another example, the light incident surface 11 may be the two lateral surfaces connecting the first light emitting surface 12 and the second light emitting surface 13. Yet in another example, the light incident surface 11 may be the three or four lateral surfaces connecting the first light emitting surface 12 and the second light emitting surface 13. The light source may include a LED light source.

FIG. 2 is a schematic view of the backlight module in accordance with one embodiment. As shown in FIG. 2, the backlight module includes a light source 20 and the light guiding plate 10. The light guiding plate 10 includes a light incident surface, a first light emitting surface, and a second light emitting surface. The light incident surface is configured for guiding the light beams from the light source toward the light guiding plate. The first light emitting surface is configured for guiding a portion of the light beams within the light guiding plate to emit out from the first light emitting surface. The light beams emitted from the first light emitting surface operate as a first light source for a first display panel. The second light emitting surface is opposite to the first light emitting surface. The second light emitting surface is configured to guide other portion of the light beams to emit out from the second light emitting surface. The light beams emitted from the second light emitting surface operate as a second light source for a second display panel.

The first light emitting surface and the second light emitting surface are respectively configured with a plurality of prism microstructures and a plurality of dot microstructures to enhance the brightness of the light beams emitted out from the first light emitting surface and the second light emitting surface.

The light guiding plate 10 may be the light guiding plate in the above embodiments, and thus the structures are omitted hereinafter.

In one embodiment, the light guiding plate 10 includes the first light emitting surface and the second light emitting surface opposite to each other. The first light emitting surface and the second light emitting surface are respectively configured with a plurality of prism microstructures and a plurality of dot microstructures to enhance the brightness of the light beams emitted out from the first light emitting surface and the second light emitting surface. In the embodiment, the prism microstructures are integrated into the light guiding plate 10 such that prism enhancement sheets at two sides of the light guiding plate 10 of the double-sided display may be omitted, which results in a thinner and lighter double-sided display.

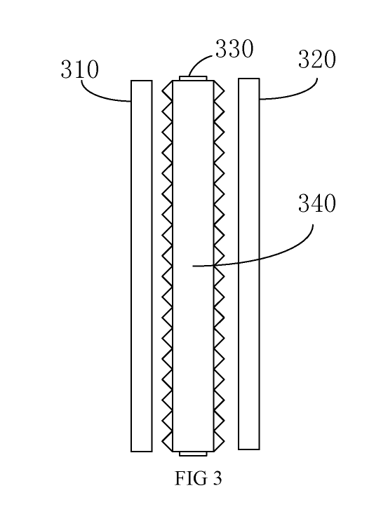

FIG. 3 is a schematic view of the double-sided display in accordance with one embodiment. The double-sided display includes a first display panel 310, a second display panel 320 a light source 330, and a light guiding plate 340. The light source 330 is arranged on at least one lateral surface of the light guiding plate 340. The light source 330 and the light guiding plate 340 are arranged between the first display panel 310 and the second display panel 320.

The light guiding plate 340 includes a light incident surface, a first light emitting surface, and a second light emitting surface. The light incident surface is configured for guiding the light beams from the light source 330 toward the light guiding plate 340. The first light emitting surface is configured for guiding a portion of the light beams within the light guiding plate 340 to emit out from the first light emitting surface. The light beams emitted from the first light emitting surface operate as a first light source for the first display panel 310. The second light emitting surface is opposite to the first light emitting surface. The second light emitting surface is configured to guide other portion of the light beams to emit out from the second light emitting surface. The light beams emitted from the second light emitting surface operate as a second light source for the second display panel 320.

The first light emitting surface and the second light emitting surface are respectively configured with a plurality of prism microstructures and a plurality of dot microstructures to enhance the brightness of the light beams emitted out from the first light emitting surface and the second light emitting surface.

The light guiding plate 340 may be the light guiding plate in the above embodiments, and thus the structures are omitted hereinafter.

In one embodiment, the light guiding plate 340 includes the first light emitting surface and the second light emitting surface opposite to each other. The first light emitting surface and the second light emitting surface are respectively configured with a plurality of prism microstructures and a plurality of dot microstructures to enhance the brightness of the light beams emitted out from the first light emitting surface and the second light emitting surface. In the embodiment, the prism microstructures are integrated into the light guiding plate 340 such that prism enhancement sheets at two sides of the light guiding plate 340 of the double-sided display may be omitted, which results in a thinner and lighter double-sided display.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guiding plate, comprising:
a light incident surface is configured for guiding light beams from a light source toward the light guiding plate;
a first light emitting surface is configured for guiding a portion of the light beams within the light guiding plate to emit out from the first light emitting surface, and the light beams emitted from the first light emitting surface operate as a first light source for a first display panel;
a second light emitting surface is configured to guide other portion of the light beams to emit out from the second light emitting surface, and the light beams emitted from the second light emitting surface operate as a second light source for a second display panel;
wherein the first light emitting surface and the second light emitting surface are respectively configured with a plurality of prism microstructures and a plurality of dot microstructures to enhance a brightness of the light beams emitted out from the first light emitting surface and the second light emitting surface;
the prism microstructures and the dot microstructures on the first light emitting surface are respectively symmetrical with the prism microstructures and the dot microstructures on the second light emitting surface; and
the light incident surface is a lateral surface connecting the first light emitting surface and the second light emitting surface, and the light source is arranged on an axis on the light incident surface.

2. The light guiding plate as claimed in claim 1, wherein the prism microstructures are arranged on the first light emitting surface and the second light emitting surface in sequence, and the prism microstructures are parallel to each other.

3. The light guiding plate as claimed in claim 2, wherein an apex angle of each of the prism microstructures is in a range between 80 and 120 degrees.

4. The light guiding plate as claimed in claim 2, wherein the dot microstructures on the first light emitting surface and the second light emitting surface are configured between two adjacent prism microstructures.

5. The light guiding plate as claimed in claim 4, wherein a gap between two adjacent dot microstructures on the same light emitting surface is in a range between 10 and 100 microns.

6. A light guiding plate, comprising:
a light incident surface is configured for guiding light beams from a light source toward the light guiding plate;
a first light emitting surface is configured for guiding a portion of the light beams within the light guiding plate to emit out from the first light emitting surface, and the light beams emitted from the first light emitting surface operate as a first light source for a first display panel;
a second light emitting surface is configured to guide other portion of the light beams to emit out from the second light emitting surface, and the light beams emitted from the second light emitting surface operate as a second light source for a second display panel; and
wherein the first light emitting surface and the second light emitting surface are respectively configured with a plurality of prism microstructures and a plurality of dot microstructures to enhance a brightness of the light beams emitted out from the first light emitting surface and the second light emitting surface.

7. The light guiding plate as claimed in claim 6, wherein the prism microstructures and the dot microstructures on the first light emitting surface are respectively symmetrical with the prism microstructures and the dot microstructures on the second light emitting surface.

8. The light guiding plate as claimed in claim 7, wherein the prism microstructures are arranged on the first light emitting surface and the second light emitting surface in sequence, and the prism microstructures are parallel to each other.

9. The light guiding plate as claimed in claim 8, wherein an apex angle of each of the prism microstructures is in a range between 80 and 120 degrees.

10. The light guiding plate as claimed in claim 8, wherein the dot microstructures on the first light emitting surface and the second light emitting surface are configured between two adjacent prism microstructures.

11. The light guiding plate as claimed in claim 10, wherein a gap between two adjacent dot microstructures on the same light emitting surface is in a range between 10 and 100 microns.

12. The light guiding plate as claimed in claim 6, wherein the light incident surface is a lateral surface connecting the first light emitting surface and the second light emitting surface, and the light source is arranged on an axis on the light incident surface.

13. A double-sided display, comprising:
a first display panel;
a second display panel;
a light source;
a light guiding plate, the light source is arranged on at least one lateral surface of the light guiding plate, the light source and the light guiding plate are arranged between the first display panel and the second display panel, and the light guiding plate comprises:
a light incident surface is configured for guiding light beams from a light source toward the light guiding plate;
a first light emitting surface is configured for guiding a portion of the light beams within the light guiding plate to emit out from the first light emitting surface, and the light beams emitted from the first light emitting surface operate as a first light source for a first display panel;
a second light emitting surface is configured to guide other portion of the light beams to emit out from the second light emitting surface, and the light beams emitted from the second light emitting surface operate as a second light source for a second display panel; and
wherein the first light emitting surface and the second light emitting surface are respectively configured with a plurality of prism microstructures and a plurality of dot microstructures to enhance a brightness of the light beams emitted out from the first light emitting surface and the second light emitting surface.
